(19) United States
(12) Patent Application Publication
(10) Pub. No.: US 2010/0158392 A1
(43) Pub. Date: Jun. 24, 2010

(54) Systems and Methods for Determining Crystallographic Characteristics of a Material

(75) Inventors: Brent L. Adams, Midway, UT (US); David T. Fullwood, Provo, UT (US); Colin D. Landon, Cambridge, MA (US); Joshua P. Kacher, Champaign, IL (US); John A. Basinger, IV, Provo, UT (US); Stuart L. Wright, Orem, UT (US)

Correspondence Address: HAMILTON, DESCANCTIS & CHA (GENERAL), 8601 W. CROSS DRIVE, F5-301, LITTLETON, CO, 80123, US

(73) Assignee: Brigham Young University

(21) Appl. No.: 12/564,221

(22) Filed: Sep. 22, 2009

Related U.S. Application Data
(60) Provisional application No. 61/192,962, filed on Sep. 22, 2008.

(51) Int. Cl. G06K 9/68

(52) U.S. Cl. 382/218; 382/278

(57) ABSTRACT

Various embodiments of the present invention provide systems and methods for determining crystallographic characteristics of a material sample. For example, a method for determining crystallographic characteristics of a sample is disclosed that includes receiving a measured image of a sample; receiving a simulated image corresponding to the sample with the simulated image being substantially free of elastic strain; comparing the measured image with the simulated image such that at least a portion of a difference between the measured image and the simulated image corresponds to an elastic strain of the sample; and using the difference to calculate the elastic strain of the sample.

### CROSS REFERENCE TO RELATED APPLICATIONS

The present application claims priority to (is a non-provisional of) Provisional U.S. Pat. App. No. 61/192,962 entitled “APPLICATION OF CORRELATION-BASED EBSD TO MEASURE ELASTIC DEFORMATION TENSOR IN Al AND Mg ALLOYS” and filed by Adams et al. on Sep. 22, 2008; and Provisional U.S. Pat. App. No. ______ (Attorney Docket No. 09-76) entitled “PATTERN CENTER POSITION FOR EBSD MICROSCOPY” and filed by Adams et al. on Aug. 24, 2009. The entirety of both of the aforementioned references are incorporated herein by reference for all purposes.

### STATEMENT REGARDING FEDERALLY FUNDED RESEARCH

The U.S. Government has a paid-up license in this invention and the right in limited circumstances to require the patent owner to license others on reasonable terms as provided for by the terms of Grant No. ARMY/ARO W911NF-08-1-0350 awarded by US ARMY.

### BACKGROUND OF THE INVENTION

The present inventions are related to systems and methods for determining characteristics of a material, and more particularly to systems and methods for determining crystallographic characteristics of a material.

Electron Backscatter Diffraction (EBSD) has been used to measure both orientation and strain characteristics of crystalline and polycrystalline materials. In many cases, the resolution of one or both of the orientation characteristic and the strain characteristic is limited. For example, various applications yield an orientation resolution of approximately 0.5 degrees, and are largely insensitive to elastic strain. Such resolution limits the value of any information obtained about a material. One approach to improve the limited orientation resolution and increase sensitivity to elastic strain involves comparing a material under test to a previously analyzed material sample. In the approach, however, any measurement of strain of the material under test is affected by the amount of strain exhibited in the previously analyzed material. As it is unlikely to find a material that is strain free to act as a reference, the reliability of any measurements achieved using the approach is limited.

Hence, for at least the aforementioned reasons, there exists a need in the art for advanced systems and methods for determining material characteristics.

### BRIEF SUMMARY OF THE INVENTION

The present inventions are related to systems and methods for determining characteristics of a material, and more particularly to systems and methods for determining crystallographic characteristics of a material.

Various embodiments of the present invention provide methods for determining crystallographic characteristics of a sample. Such methods include receiving a measured image of the sample; calculating a lattice orientation of the sample based at least in part on the measured image; generating a simulated image corresponding to an expected crystal structure of the sample and the calculated lattice orientation; calculating a difference between the measured image and the simulated image; and calculating a displacement gradient tensor based at least in part on the difference. In some instances of the aforementioned embodiments, the measured image is an EBSD pattern. In some cases, the methods further include providing an electron microscope and a detector. The electron microscope directs a band of electrons toward the sample, and the detector creates a preliminary image based upon a number of electrons emitted from the sample due to the band of electrons that interact with the detector. In such a case, the measured image is a derivative of the preliminary image. In some cases, various processing (e.g., image filtering) may be applied to the measured image to improve the quality of the EBSD pattern.

In some instances of the aforementioned embodiments, calculating the difference includes cross correlating the measured image with the simulated image. Such cross correlating may be performed using fast Fourier transforms. In various instances of the aforementioned embodiments, calculating the lattice orientation of the sample based at least in part on the measured image includes detecting bands in the measured image. Such detection may be facilitated through use of one or more of a Hough transform method, a Radon transform method, or the Burns method. In particular instances of the aforementioned embodiments, generating the simulated image includes using a kinematical based model of electron diffraction. In other instances of the aforementioned embodiments, generating the simulated image includes using dynamical based model of electron diffraction.

In various instances of the aforementioned embodiments, the methods further include segregating the measured image into a plurality of sub-regions and segregating the simulated image into the plurality of sub-regions. These sub-regions are referred to herein as regions of interest in some cases. In such instances, calculating a difference between the measured image and the simulated image may be done on a sub-region by sub-region basis. In some such instances, the methods may further include re-calculating the lattice orientation of the sample based at least in part on the displacement gradient tensor. The processes of generating the simulated image using the newly calculated lattice orientation, calculating a difference between the measured image and the simulated image, calculating a displacement gradient tensor based at least in part on the newly calculated difference may be iteratively performed until the displacement gradient tensor exhibits a predefined condition. Determining whether the displacement gradient tensor exhibits the predefined condition may include, but is not limited to, summing the magnitudes of calculated differences from the plurality of sub-regions to yield a difference value, and determining whether the difference value is below a predefined threshold; or calculating a factor based on the magnitudes of the components of the displacement gradient tensor, and determining whether the factor is below a predefined threshold.

Some instances of the aforementioned embodiments of the present invention further include calculating an elastic strain tensor for the sample based at least in part on the displacement gradient tensor. In such instances, the simulated image may be assumed to be free of elastic strain. In some cases, the methods further include repeating the various processes to determine the elastic strain tensor for a plurality of points on the sample.

One or more instances of the aforementioned embodiments of the present invention further include performing a pattern center calibration that approximates the pattern center of the measured image. In some such cases, the measured image is represented in spherical coordinates and includes at least one spherical band including a first outer edge and a second outer edge, and the pattern center calibration includes estimating a pattern center, and determining whether the estimated pattern center yields the at least one spherical band with the first outer edge substantially parallel to the second outer edge. In particular cases, the processes of estimating the pattern center and determining whether the estimated pattern center yields the at least one spherical band with the first outer edge substantially parallel to the second outer edge are iteratively performed until a degree of parallelism of the first outer edge relative to the second outer edge is within a pre-defined convergence criterion. Such a pre-defined convergence criterion may be, but is not limited to, a maximum correlation between a parallel spherical band and the actual spherical band corresponding to the estimated pattern center. As another example, such a pre-defined convergence criterion may include substantially similar widths of the spherical band suggesting substantially parallel outer edges of the band. Based upon the disclosure provided herein, one of ordinary skill in the art will recognize other pre-defined convergence criterion that may be used in relation to different embodiments of the present invention.

Other embodiments of the present invention provide systems for determining crystallographic characteristics of a sample. Such systems include a data processing circuit that is operable to receive a measured image of a sample; receive a simulated image corresponding to the sample that is substantially free of elastic strain; compare the measured image with the simulated image to yield a difference; and to calculate the elastic strain of the sample using the difference where at least a portion of the difference corresponds to an elastic strain of the sample. In some instances of the aforementioned embodiments, the system further includes an electron microscope and a detector. The electron microscope directs a band of electrons (i.e., a stream of electrons) toward the sample. The band of electrons interacts with a material point in the sample. This interaction is commonly referred to as back scattering. Backscattered electrons are a derivative of the initial band of electrons, with some of the backscattered electrons impinging upon the surface of the detector resulting in a preliminary image. The measured image is a derivative of the preliminary image. In some instances of the aforementioned embodiments, the data processing circuit is further operable to calculate the lattice orientation of the sample based at least in part on the difference. In such cases, the simulated image corresponds to the sample at the calculated lattice orientation. The processes of receiving the simulated image corresponding to the sample, comparing the measured image with the simulated image to yield a difference, and calculating the lattice orientation of the sample based at least in part on the difference may be iteratively performed until the difference is less than a predefined threshold. In such cases, the elastic strain of the sample is calculated using the difference remaining after iteratively performed processes. In one or more instances of the aforementioned embodiments, the system further includes a pattern center estimation circuit that is operable to perform a pattern center calibration that approximates the pattern center of the measured image. In some cases, the data processing circuit is a general purpose circuit, such as a microprocessor communicably coupled to a computer readable medium such as a random access memory, that executes instructions to perform the various processes. In other cases, the data processing circuit is a circuit specifically tailored for performing the aforementioned operations. Similarly, in some cases, the pattern center estimation circuit is a general purpose circuit, such as a microprocessor communicably coupled to a computer readable medium such as a random access memory, that executes instructions to perform the various processes. In other cases, the pattern center estimation circuit is a circuit specifically tailored for performing the aforementioned operations.

Yet other embodiments of the present invention provide methods for determining crystallographic characteristics of a sample. The methods include receiving a measured image of a sample; receiving a simulated image corresponding to the sample with the simulated image being substantially free of elastic strain; comparing the measured image with the simulated image such that at least a portion of a difference between the measured image and the simulated image corresponds to an elastic strain of the sample; and using the difference to calculate the elastic strain of the sample.

Some embodiments of the present invention provide methods for determining the mis-orientation between two points in a sample. Determining the mis-orientation between two points in a sample may include: (a) receiving a first measured image for a first point on the sample; (b) calculating a first lattice orientation of the sample based at least in part on the first measured image; (c) generating a first simulated image corresponding to an expected crystal structure of the sample and the calculated first lattice orientation; (d) correlating the generated first simulated image with the first measured image to determine a first displacement gradient tensor; (e) based at least in part on the first displacement gradient tensor, updating the first calculated lattice orientation; (f) repeating elements (c) through (f) at least once to yield a first final modified lattice orientation; (g) receiving a second measured image for a second point on the sample; (h) calculating a second lattice orientation of the sample based at least in part on the second measured image; (i) generating a second simulated image corresponding to an expected crystal structure of the sample and the calculated second lattice orientation; (j) correlating the generated second simulated image with the second measured image to determine a second displacement gradient tensor; (k) based at least in part on the second displacement gradient tensor, updating the second calculated lattice orientation; (l) repeating elements (i) through (k) at least once to yield a second final modified lattice orientation; and (m) calculating a mis-orientation between the first final modified lattice orientation and the second final modified lattice orientation to yield a mis-orientation output.

Yet other embodiments of the present invention provide methods for determining a crystal structure of a sample. Such methods include: (a) receiving a measured image of the sample; (b) calculating a lattice orientation of the sample based at least in part on the measured image; (c) generating a first simulated image corresponding to a first comparative crystal structure of the sample and the calculated lattice orientation; (d) correlating the generated first simulated image with the measured image to determine a first displacement gradient tensor; (e) based at least in part on the first displacement gradient tensor, updating the calculated lattice orientation; (f) repeating elements (c) through (f) at least once to yield a first final displacement gradient tensor; (g) generating a second simulated image corresponding to a second comparative crystal structure of the sample and the calculated lattice orientation; (h) correlating the generated second simulated image with the measured image to determine a second displacement gradient tensor; (i) based at least in part on the second displacement gradient tensor, updating the calculated lattice orientation; (j) repeating elements (g) through (i) at least once to yield a second final displacement gradient tensor; and comparing the first final displacement gradient tensor with the second final displacement gradient tensor to identify the crystal structure as one of first comparative crystal structure or the second comparative crystal structure.

This summary provides only a general outline of some embodiments of the invention. Many other objects, features, advantages and other embodiments of the invention will become more fully apparent from the following detailed description, the appended claims and the accompanying figures.

### BRIEF DESCRIPTION OF THE DRAWINGS

A further understanding of the various embodiments of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 shows a material analysis system in accordance with various embodiments of the present invention;

FIG. 2 is a flow diagram showing a method in accordance with some embodiments of the present for determining elastic strain in a material;

FIG. 3 provides a graphical depiction used to show the reflection of an electron beam off of two reflecting lattice planes of a material that result in generation of bands on a phosphor screen;

FIG. 4a is an exemplary image including bands resulting from reflection of an electron beam off of a material and onto a phosphor screen;

FIG. 4b depicts the measured image of FIG. 4a next to a simulated image corresponding to the same material that was used to create the image of FIG. 4a;

FIGS. 5a-5b are flow diagrams depicting methods in accordance with some embodiments of the present invention for performing pattern center calibration; and

FIGS. 6a-6b depict exemplary planar and spherical representations of bands to describe the methods for performing pattern center calibration of FIGS. 5a-5b.

### DETAILED DESCRIPTION OF THE INVENTION

The present inventions are related to systems and methods for determining characteristics of a material, and more particularly to systems and methods for determining crystallographic characteristics of a material.

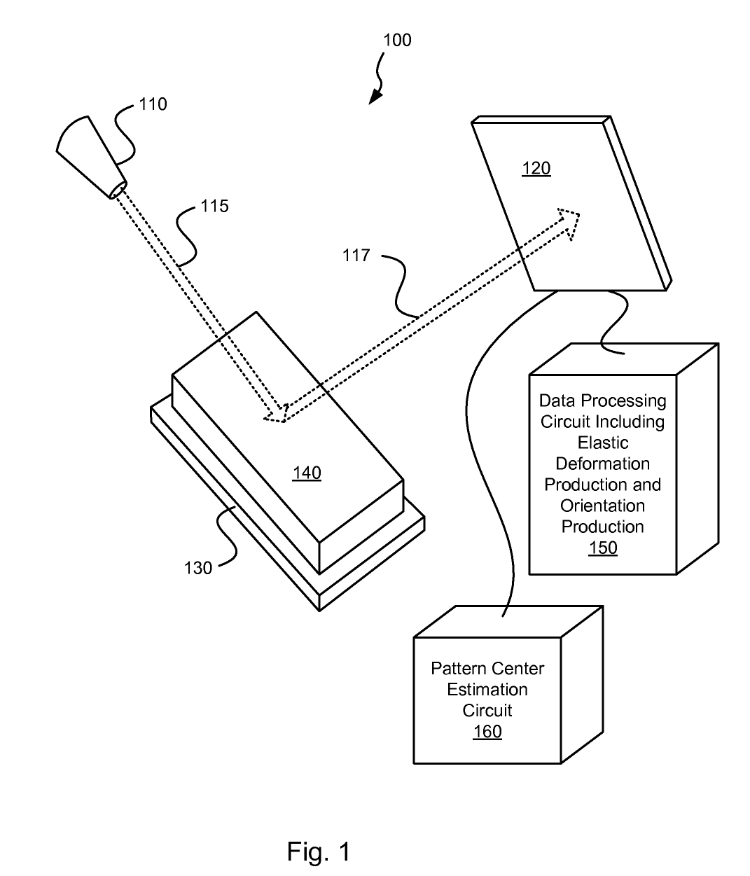

Turning to FIG. 1, shows a material analysis system 100 in accordance with various embodiments of the present invention. Material analysis system 100 includes a radiation source 110 that in this case emits an electron beam 115 toward a material sample 140 that is placed on a carrier 130. Electron beam 115 reflects off of one or more lattice planes of the material sample as a diffracted electron beam 117 toward a detector 120. Diffracted electron beam 117 creates an electron backscatter diffraction (EBSD) image on a surface of detector 120 that is transferred to a data processing circuit 150 and a pattern center estimation circuit 160.

Material sample 140 may be any crystalline or polycrystalline material. As an example, material sample 140 may be magnesium or some alloy thereof, or a single crystal silicon sample. Based upon the disclosure provided herein, one of ordinary skill in the art will recognize a variety of materials that may be examined using embodiments of the present invention. Material sample 140 may be placed in a highly-tilted (e.g., approximately seventy degrees) orientation relative to electron beam 115.

Radiation source 110 may be any device or system capable of emitting a beam of radiation, and detector 120 may be any device or system capable of detecting all or part of the emitted beam and providing an image corresponding to the detected beam. As an example, radiation source 110 and detector 120 may be a Phillips® XL30 S-FEG microscope equipped with a phosphor screen and a charge coupled device (CCD) camera. As another example, radiation source 110 and detector 120 may be a FEI DualBeam™ SEM/FIB system equipped with a Hikari® high speed camera. Based upon the disclosure provided herein, one of ordinary skill in the art will recognize a variety of sources and detectors that may be used in accordance with different embodiments of the present invention.

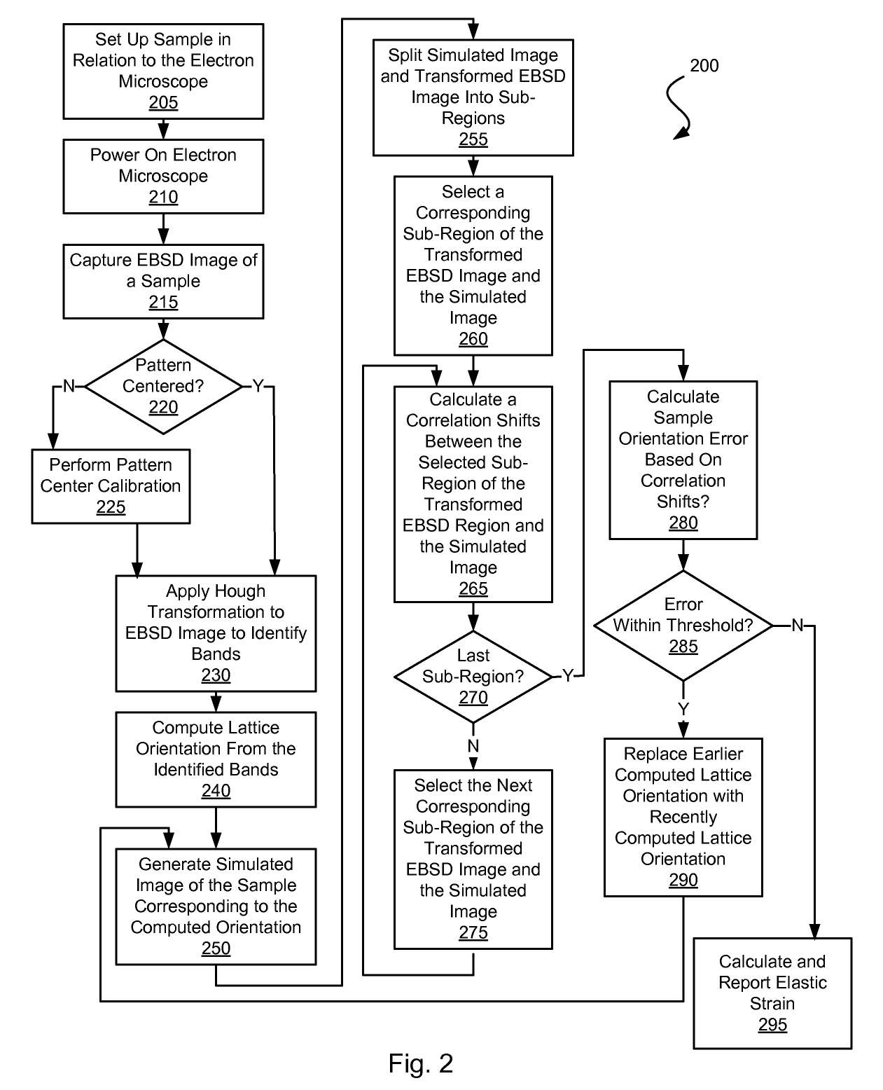

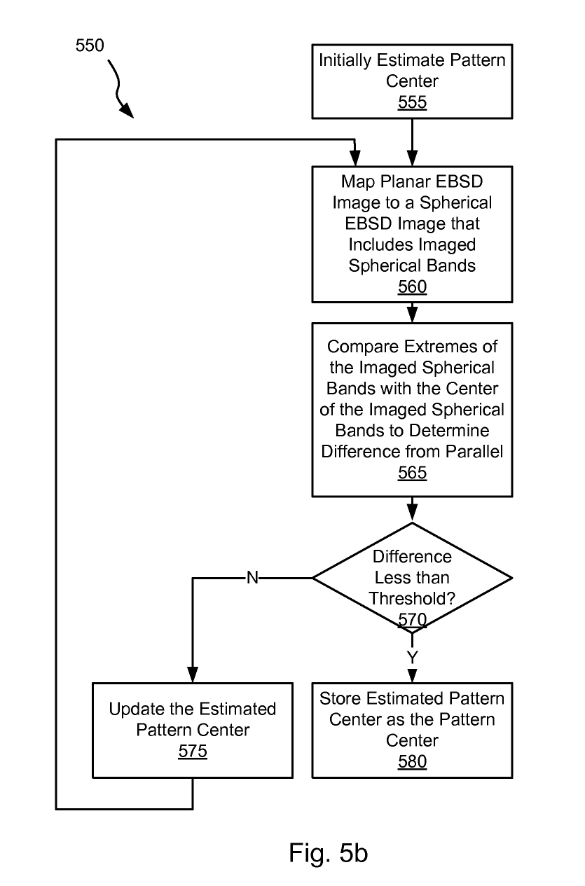

Data processing circuit 150 receives a measured image from detector 120 and performs a variety of processing on the image to yield both a lattice orientation corresponding to discrete locations of the sample material and nine components of the elastic deformation gradient tensor corresponding to the discrete locations of the sample material. One or more of the components of the elastic deformation gradient tensor may be generically referred to herein as elastic strain. Pattern center estimation circuit 160 receives an image from detector 120 and performs a variety of processing on the image to yield an estimated pattern center that may be used by data processing circuit 150. In some embodiments of the present invention, data processing circuit 150 and pattern center estimation circuit 160 perform one or more of the processes discussed below in relation to FIG. 2 and FIGS. 5a-5b. As used herein, the term “circuit” or “circuitry” is used in its broadest sense to mean any device or system capable of receiving an input and providing an output. Thus, for example, a circuit may be a grouping of electronic components that receive an input in an electrical format, perform one or more hardwired processes on that input, and provide a processed output in an electrical format. Alternatively, or in addition, a circuit may be a generalized processor that receives an input, executes one or more instructions causing manipulation of the input, and provides a processed output. Based upon the disclosure provided herein, one of ordinary skill in the art will recognize a variety of circuits that may be used to implement data processing circuit 150 and pattern center estimation circuit 160. In one particular embodiment of the present invention, data processing circuit 150 and pattern center estimation circuit 160 include a general purpose processor and a computer readable medium. The computer readable medium includes instructions executable by the general purpose processor to perform one or more of the processes discussed below in relation to FIG. 2 and FIGS. 5a-5b. The computer readable medium may be any medium that is accessible by the processor. Thus, the computer readable medium may be, but is not limited to, a random access memory, a read only memory, a magnetic memory, a hard disk drive, a tape drive, an optical device, combinations of the aforementioned, or the like. The instructions executable by the general purpose processor may be, but are not limited to, software or firmware instructions. Based upon the disclosure provided herein, one of ordinary skill in the art will recognize a variety of computer readable media and instructions that may be used in relation to different embodiments of the present invention.

In some embodiments of the present invention, pattern center estimation circuit 160 analyzes an image of electrons leaving the sample and impinging on the detector. When the electrons hit the detector, the pattern is distorted due to the flat surface of the detector. Where the pattern center is correctly identified, the image from the planar surface of the detector when mapped onto a sphere which has its center given by this pattern center, then the pattern on the sphere will correspond with parallel bands centered on great circles. Alternatively, where the pattern center is not correctly identified, then mapping onto the sphere from the phosphor image will cause a distorted pattern on the sphere, with bands that lose their properties of parallelism and are no longer centered on great circles. The nature/magnitude of this distortion will be directly determined by the error in the pattern center approximation. In some cases, the distortion may be determined by comparing the actual image converted to spherical coordinates with a simulated pattern, or by comparing simply with parallel bands (centered on great circles around the sphere). In other embodiments, sub-regions of the image derived from the detector may be analyzed to determine the distortion on a sphere away from the ideal (great circle-centered bands) pattern. Based upon this equations may be used that link this distortion to errors in x,y,z for the pattern center, which can subsequently be corrected, thus leading to a new estimate.

Turning to FIG. 2, a flow diagram 200 shows a method in accordance with some embodiments of the present for determining elastic strain in a material. Following flow diagram 200, a sample material is disposed in relation to an electron microscope (block 205). This may include, for example, placing the sample material on a carrier apparatus such that radiation emitted from a radiation source is directed toward the surface of the sample material at a desired incidence angle. The electron microscope is then turned on such that an electron beam emitted from the radiation source impacts the surface of the sample material (block 210).

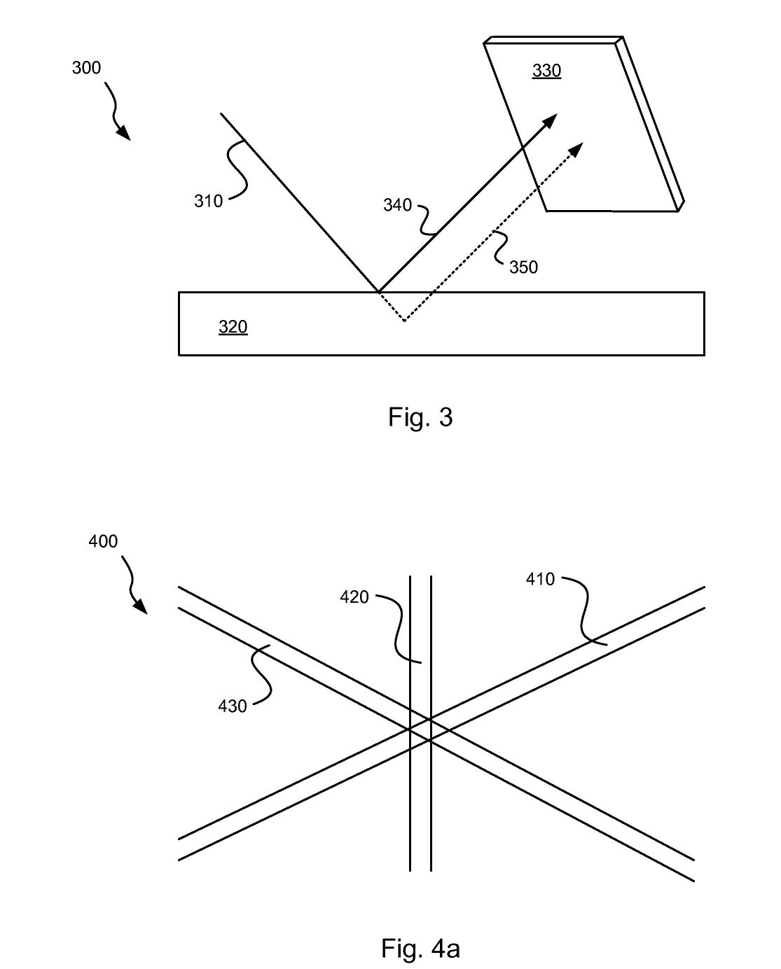

As shown in FIG. 3, the interaction of an electron beam 310 on a sample material 320 results in a diffraction volume within sample material 320. Sample material 320 then acts as an electron source with electrons being scattered in all possible directions. As the scattered electrons interact with crystallographic planes within the lattice of sample material 320, those satisfying Bragg's law are coherently diffracted out of sample material 320 along the crystal planes. The coherently diffracted electrons are represented by a vector 340 and a vector 350, with each vector being directed toward a planar detector 330. The spacing between vector 340 and vector 350 creates a band at the surface of detector 330. Bragg's Law is given by the following equation:

mλ=2dₕₖₗ sin Θ,

where λ is the wavelength of electron beam 310, dₕₖₗ is the interplanar spacing, and Θ is the angle between electron beam 310 and the scattered wave. In this case, m is an integer that denotes the order of the diffraction band. In some cases, calculating the simulated image relies on only the first order (m=1) diffraction bands. The wavelength is a function of the energy of electron beam 310. Increasing the energy decreases the width of the bands defined by the interaction of vectors 340, 350 with the surface of detector 330. The width of the bands is also function of the interplanar spacing of the lattice of sample material 320. As dₕₖₗ increases, Θ must decrease to maintain Bragg's law.

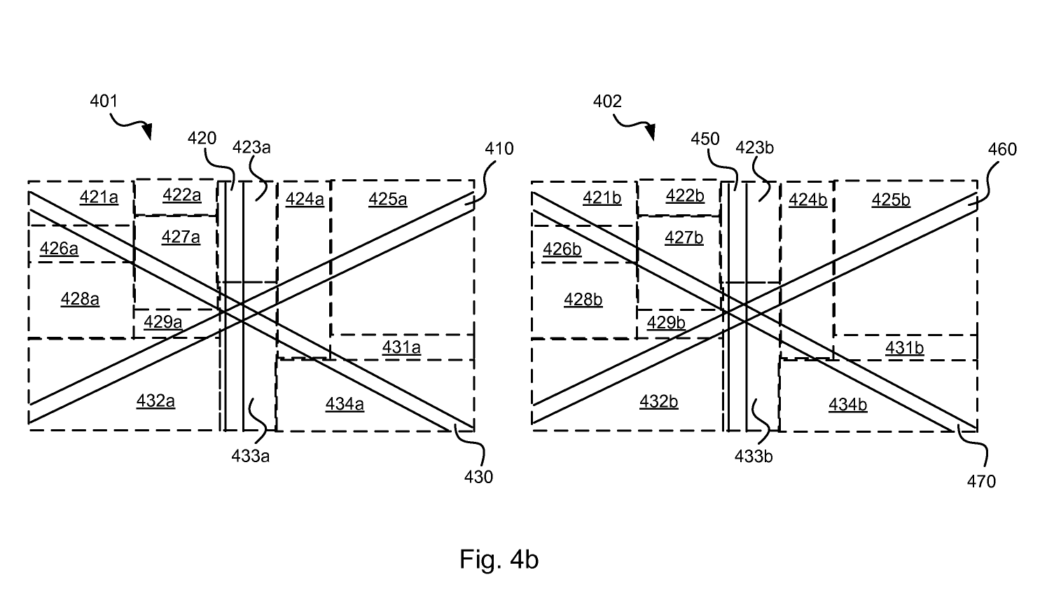

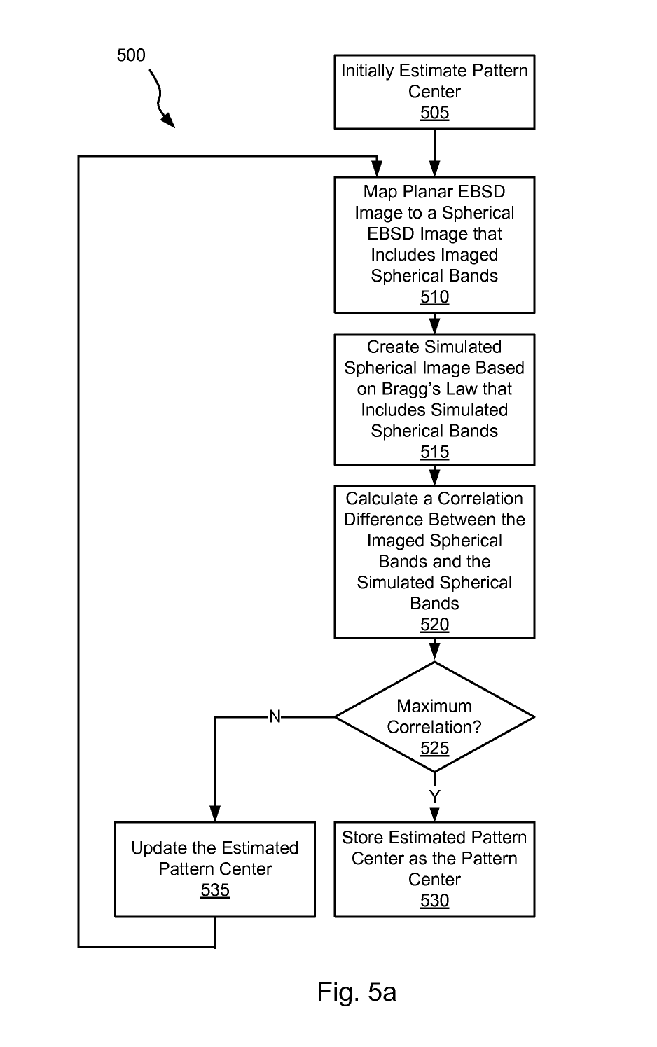

The impact of electrons corresponding to vector 340 and vector 350 on the surface of the detector creates an EBSD image that is captured for subsequent processing (block 215). The image capture may be done using any image capture device or system known in the art. For example, the detector may include a phosphor screen that is imaged using a CCD camera as are known in the art. It is then determined whether the pattern is properly centered (block 220). In some cases, this is determined by whether or not a pattern center calibration has been performed. Where the pattern center has not been determined (block 220), a pattern center calibration is performed (block 225). Examples of such pattern center calibration are discussed below in relation to FIGS. 5a-5b. Where the pattern center has been determined (block 220) or once the pattern center calibration is complete (block 225), a Hough transformation is applied to the captured EBSD image to identify the bands. The use of the Hough transformation is the most common technique employed to detect the bands in the pattern. It should be noted, however, that in different embodiments of the present inventions other transforms or manipulations may be used to identify the banding including, but not limited to, the Radon transform method or the Burns method as are known in the art. FIG. 4a depicts an exemplary Hough transformed image 400 including a number of bands 410, 420, 430. It should be noted that image 400 is merely exemplary and that a number of different images are possible with varying numbers of bands depending upon the sample material and the configuration of the radiation source and detector.

The lattice orientation is then computed (block 240). The lattice orientation may be computed consistent with that disclosed in B. L. Adams, S. I. Wright, K. Kunze, “Orientation imaging: the emergence of a new microscopy”, Metallurgical Transactions A (Physical Metallurgy and Materials Science) 24A (4) (1993) pp. 819-31; and S. I. Wright, “Review of automated orientation imaging microscopy (OIM)”, Journal of Computer-Assisted Microscopy 5 (207) (1993). The entirety of both of the aforementioned documents is incorporated herein by reference for all purposes. Such computation results in an orientation value that is within approximately 0.5 degree of the actual orientation.

A simulated image of the sample is generated that corresponds to the sample with the previously computed lattice orientation (block 250). In some embodiments of the present invention, high resolution simulated images are generated. In other embodiments of the present invention, lower resolution simulated images are used that limit the computational requirements of the process. In one particular embodiment of the present invention, a simulated image of the sample is generated using simulated EBSD patterns that are generated at known lattice states for the particular material. Various approaches for generating simulated images may be used including, but not limited to, an approach based upon a kinematical based model of electron diffraction, or an approach based upon a dynamical based model of electron diffraction.

This approach relies on simple geometric relations that connect a crystal lattice state to its projected EBSD image. In order to represent the relations mathematically, several reference frames are established. The first reference frame is the crystal frame, êᵢ^{c}, with the local crystal lattice parameters defining the basis vectors. This simulated reference pattern is designed to be stress free, with only the rotation component of the elastic deformation tensor being used to rotate the global reference lattice vectors to the local lattice. The second reference frame is the standard, ê₃^{s} normal to the sample surface, ê₁^{s} in the rolling direction, and ê₂^{s} in the transverse direction. The sample frame is taken to be the external reference frame so that the rotation component of the local elastic deformation tensor is exactly the previously calculated orientation (block 240). The third reference frame of interest is attached to the phosphor screen used to collect the EBSD images and is related to the pixilated image so that ê₁^{v} points from left to right in the image (i.e., in increasing pixel columns), ê₂^{v} points from top to bottom in the image (i.e., in increasing pixel increasing rows), and ê₃^{v} completes the orthonormal right-handed frame. A vector described in any of these three frames may also be rotated into another using a second rank tensor that describes a pure rotation. For example,

vᵢ^{s}=Rᵢⱼ^{v→s}vⱼ^{v}.

Considering the Bragg's Law relationship, mλ=2dₕₖₗ sin Θ, that describes two cones of angle Θ that bound the diffraction band from the hkl plane for a wavelength λ (in this case, m is an integer that denotes the order of the diffraction band). In some cases, calculating the simulated image relies on only the first order (m=1) diffraction bands. The deformation tensor, F, determines how the diffraction cones are oriented with respect to the phosphor frame and may also change the inter-planar spacing, dₕₖₗ. Because the equation of a cone is easiest to describe in the frame in which it is a right rectangular cone with the axis of symmetry in the z-axis, a fourth right-handed, orthonormal reference frame may be defined for convenience. Determination of a plane normal (e.g., the hkl crystallographic plane) after deformation is a standard mechanics problem and can be found using the following equation:

\hat{n}′=a(\hat{n})^{T}(F)⁻¹,

where \hat{n}′ is the normal after deformation, \hat{n} is the plane normal before deformation, and a is a scalar normalization. The cone reference frame is then aligned such that ê₁^{CO}=\hat{n}′, 0=ê₂^{CO}ê₃^{CO}, and ê₁^{CO}=ê₂^{CO}×ê₃^{CO}. In the cone reference frame, a point \vec{p}=p₁ê₁^{CO}+p₂ê₂^{CO}+p₃ê₃^{CO} lies on the cone if p₁²+p₂²=(p₃/tan(Θ))², where the angel is the same as the angle Θ. The EBSD image is an array (Ncolumn by Nrow) of pixel data, and each pixel can be described as a point in the cone reference frame. If a pixel falls on or between the two cones corresponding to a chosen refracting plane (hkl), then that pixel in the image of the simulated band, B, is taken to have an intensity equal to the square of the structure intensity, Sₕₖₗ, and zero otherwise

$$B ( {p}^{->} , F , {R}^{v -> c} , {R}^{c -> CO} , ( hkl ) ) = \{ \begin{matrix}{S}_{hkl}^{2} , & \begin{matrix}\begin{matrix}where {( {[ {R}^{c -> CO} {FR}^{v -> c} {p}^{->} ]}_{1} )}^{2} + \\ {( {[ {R}^{c -> CO} {FR}^{v -> c} {p}^{->} ]}_{2} )}^{2} \geq \end{matrix} \\ {( \frac{{[ {R}^{c -> CO} {FR}^{v -> c} {p}^{->} ]}_{3}}{tan ( Θ )} )}^{2}\end{matrix} \\ 0 , & otherwise\end{matrix} \}$$

Summing the contributions of each band and its symmetry variants generates the complete approximation of the EBSD pattern image. If Sⁱ are the elements of the symmetry subgroup and (hkl)^{(j)} are the elements of the set that includes all of the diffracting planes, then the composite simulation image can be described as follows:

$$I ( {p}^{->} , F ) = {\sum }_{i} {\sum }_{j} B ( {p}^{->} , F , {{S}^{( i )} ( hkl )}^{( j )} .$$

The final simulated pattern can be further filtered using high and low pass filters to more accurately reflect the variations in the measured EBSD pattern background. Using the cross-correlation analysis in an iterative manner the F that minimizes the difference between a measured pattern M and a pattern simulation I(\vec{p},F) is found. Because the measured pattern is a pixilated image, the simulation image must be evaluated at the locations that correspond to those pixels.

The simulated image of the sample material (block 250) and the transformed EBSD image (block 230) are split into regions of interest or sub-regions (block 255). In some embodiments of the present invention, the number of sub-regions is between ten and twenty. In other embodiments of the present invention, the number of sub-regions may be greater or less. As an example, where the transformed EBSD image is a 1000×1000 pixel image, a number of 256×256 sub-regions may be formed. In some cases, the sub-regions may overlap and thereby share pixels between sub-regions. In other cases, the sub-regions may include mutually exclusive pixels.

FIG. 4b depicts a transformed EBSD image 401 including bands 410, 420, 430 next to a simulated image 402 including bands 450, 460, 470. As simulated image 402 represents the same sample material used to create transformed EBSD image 401, the two images are very similar with the only differences being elastic strain exhibited in the sample material, and a difference in the measured orientation of the lattice of the sample material (block 240) and the actual orientation of the lattice of the sample material. The substantial similarity between transformed EBSD image 401 and simulated image 402 includes a general correspondence between band 420 and band 450, between band 410 and band 460, and between band 430 and band 470. As shown, transformed EBSD image 401 and simulated image 402 are each divided into corresponding regions of interest. In particular, transformed EBSD image 401 includes sub-regions (i.e., regions of interest) 421a, 422a, 423a, 424a, 425a, 426a, 427a, 428a, 429a, 431a, 432a, 433a and 434a. Similarly, simulated image 402 includes sub-regions (i.e., regions of interest) 421b, 422b, 423b, 424b, 425b, 426b, 427b, 428b, 429b, 431b, 432b, 433b and 434b.

As will be discussed later, a comparison between transformed EBSD image 401 and simulated image 402 is performed to determine a difference the actual orientation of the lattice of the sample material and the previously measured orientation. After correcting for the orientation error, the remaining difference is used to calculate elastic strain of the sample material where it is assumed that the elastic strain of the simulated material is zero. The comparison process includes an averaged comparison across a region. To avoid loss of meaningful local data from the sample material, the comparison process is carried out on a region by region basis. Thus, increasing the number of regions of interest improves the local value of the information. However, leaving each region of interest with substantial size provides a greater ability for the averaging process to yield increased resolution. Based upon the disclosure provided herein, one of ordinary skill in the art will recognize a variety of numbers of regions of interest, and a variety of orientations of the regions of interest that may be used to isolate the differences between the transformed EBSD image (block 230) and the simulated image (block 250).

Returning to FIG. 2, a sub-region or region of interest in the transformed EBSD image and the corresponding one of the sub-regions in the simulated image is selected (block 260). The order in which the sub-regions are selected may be random or based on some selection algorithm. The two corresponding sub-regions are then compared to yield the approximately minimum difference between the two sub-regions or correlation shift (block 265). This correlation shift is stored in relation to the particular sub-regions. These correlation shifts are mathematically related to the components of the “displacement gradient tensor”. Said another way, an equation can be shown that relates the correlation shifts to the displacement gradient tensor. It is then determined whether all of the sub-regions have been processed (block 270). Where all of the sub-regions have not yet been processed (block 270), the next two corresponding sub-regions are selected (block 275) and the processes of block 265 and block 270 are repeated for the newly selected sub-regions.

Alternatively, where all of the sub-regions have been processed (block 270), the lattice orientation of the sample material is re-calculated using the correlation shift data (block 280). This newly calculated lattice orientation is subtracted from the earlier calculated lattice orientation to yield an orientation error, and the absolute value of the orientation error is compared against a threshold value (block 285). It should be noted that the term “subtracted” is used in its broadest sense to mean a process whereby a difference between the newly calculated lattice orientation and the earlier calculated lattice orientation is calculated. Where the orientation error is not less than the threshold value (block 285), the earlier calculated lattice orientation value is replaced with the newly calculated orientation value (block 290) and the processes of block 250 through block 285 are repeated using the newly calculated lattice orientation value. Each time the process is repeated, the orientation error decreases as the lattice orientation of the sample material is more closely approximated.

Once the orientation error is less than the threshold value (block 285), the remaining correlation shift data is used to calculate an elastic strain value for each of the regions of interest (block 295). In particular, the correlation shifts for the various sub-regions are combined using a single algorithm to create a single composite displacement gradient tensor that contains the elastic strain tensor. Of note, the correlation shift data infers the displacement gradient tensor containing the elastic strain tensor at all times, however, once the orientation error is sufficiently low, the remaining correlation shift data is assumed to be due to elastic strain. The correlation shift data is used to determine how the corresponding sub-regions in the transformed EBSD image and the simulated image would need to be shifted in order to align similar features with each other. The correlation shift data are essentially the convolution of two functions and can be calculated efficiently in the Fourier domain by the following:

C=ℑ⁻¹{ℑ{f}*conj(ℑ{g})},

wherein ℑ{ . . . } indicates the Fourier transform, conj( . . . ) indicates the complex conjugate, and * indicates an element-wise multiplication of two matrices.

The resulting image, C, shows intensity peaks related to shifts that cause similar features to be aligned. The peak intensity in the cross-correlation image, C, is located at a position described by a vector, \vec{q}, that is measured from the center of the image (e,g., if the peak appears at the center then \vec{q} would have components [0,0], or if the peak appears one pixel to the right of and one pixel down from the center then \vec{q} would have components [−1,1]). The vector \vec{q} describes how on average over the selected sub-region that features contained in the selected sub-region shift when compared to other patterns that also contain the feature. Local interpolation schemes over a number of sub-regions may allow the tracking of a feature shift down to 1/20^{th} of a pixel depending upon the particular embodiment of the present invention. Although this shift is the average of all features in the sub-region, it approximates the shift of the pattern direction, \hat{r}, found at the center of the sub-region (i.e., the pattern center). The following equation may be used to calculate the various components that describe the difference between a transformed EBSD image and a simulated image:

$$\frac{{q}^{->}}{λ} = {w}^{->} - ( {w}^{->} \cdot {\hat{r}}^{′} ) {\hat{r}}^{′} + \frac{{q}^{->} \cdot {\hat{r}}^{′}}{λ} {\hat{r}}^{′} ,$$

where \vec{q} represents the shift between the transformed EBSD image and the simulated image, \hat{r} represents the unit vector pointing from the sample material origin to the center of the sub-region on the phosphor screen, and \hat{r}′ points to the shifted position of the ROI in the deformed lattice pattern. For the purposes of this document, the aforementioned equation is referred to as the difference equation. λ is a geometrical factor given by:

λ=z*/\hat{r}^{pc}\hat{r},

where \hat{r}^{pc} is a unit vector normal to the phosphor screen that passes through the sample origin and z* is the perpendicular distance from the screen to the sample origin. The displacement under deformation is represented by the vector \vec{w}, where \vec{w}=A\hat{r}. A is the displacement gradient tensor, (A+I)=F, and F is the local deformation gradient tensor (its dependence upon location in the sample frame is implicit).

The aforementioned difference equation contains three independent independent equations, one for each component of \vec{q} (the third component of \vec{q} is uniformly zero when described in the coordinate frame of the phosphor screen, but is non-zero in other coordinate frames). Knowing the configuration of the microscope geometry and the appropriate coordinate frame transformations, \hat{r} is easily calculated for any sub-region. Using the measured shifts \vec{q}, \hat{r}′ can also be evaluated. This leaves the displacement gradient tensor as the only unknown. In addition to the three independent equations from the components of the above relationship, three more equations can be added from the appropriate form of the tractio-free boundary condition for the sample surface with unit normal \hat{r}^{pc} either in terms of stress, σ, or elastic stiffness, C, times strain, ε in accordance with the following equation:

0=σᵢⱼ\hat{r}^{pc}=Cᵢⱼₖₗεₖₗ\hat{r}ⱼ^{pc}.

For small deformations, the symmetric and asymmetric parts of the displacement gradient tensor A represent, respectively, the elastic strain and rotation according to the following equations:

$$ɛ = \frac{1}{2} ( A + {A}^{T} ) and ω = \frac{1}{2} ( A - {A}^{T} ) .$$

It should be noted that the polar decomposition theorem enables the deformation gradient tensor, F, to be expressed as the product of a proper orthogonal tensor or rotation, R, and a positive definite symmetric tensor, U, where F=RU. The displacement gradient tensor, A, is mathematically related to the deformation gradient tensor, F, by the following equation:

F=(I+A),

where I is the identity tensor. In the case of the small elastic deformations and rotations of the crystal lattice, ω can be related to the rotation tensor by R=I+ω, and ε is related by the expression: U=I+ε. Of note, all of the terms in the above equations are expressed in the same reference (e.g., crystal) frame. In some cases, \hat{r}^{pc} is expressed in the crystal frame, but until the boundary equations are evaluated, the elastic deformation is not completely known. This circular dependence may be resolved by an iterative process where an initial assumption is made about deformation, and then the calculated deformations are used to update subsequent iterations. This approach is described in detail later. The system of equations may be solved by choosing only two sub-regions. It should be noted that in various instances of the aforementioned embodiment, plastic strain, while represented in the equations, is not necessarily calculated and may be considered an artifact.

An error measure was defined to describe the fit of a calculated deformation tensor to the shifts measured on the phosphor screen. To evaluate the fit, the shifts that would have been caused by a measured deformation tensor, F, are calculated, and then the average length of the difference between the calculated and measured shifts is found. For N sub-regions in an EBSD, the measured error is defined as follows:

$${q}^{i -> c} = {}^{i} \hat{r} - ( {F}^{i} \hat{r} ) ⋂ P ;$$

$$\overline{e} = \frac{1}{N} {\sum }_{i = 1}^{N} \vert {q}^{i -> c} - {q}^{i -> m} \vert ,$$

where ⁱ\hat{r} is the direction of the center of the ith sub-region, ⁱ\vec{q}^{m} and ⁱ\vec{q}^{c} are respectively the the measured and calculated shifts of the ith sub-region, P is the plane that contains the phosphor screen and ē is the average error for all N sub-regions. The notation | . . . | denotes the scalar magnitude, and the symbol ∩ indicates the intersection of sets. The error measure, ē, describes how well the calculated F fits the measured shifts.

Exemplary results using an approach corresponding to one specific embodiment of the present invention are presented in Kacher J., Landon, C., Adams, B. L., Fullwood, D., “Bragg's Law Diffraction Simulations for Electron Backscatter Diffraction Analysis”, Ultramicroscopy 109 (2009) 1148-56. The entirety of the aforementioned article is incorporated herein by reference for all purposes.

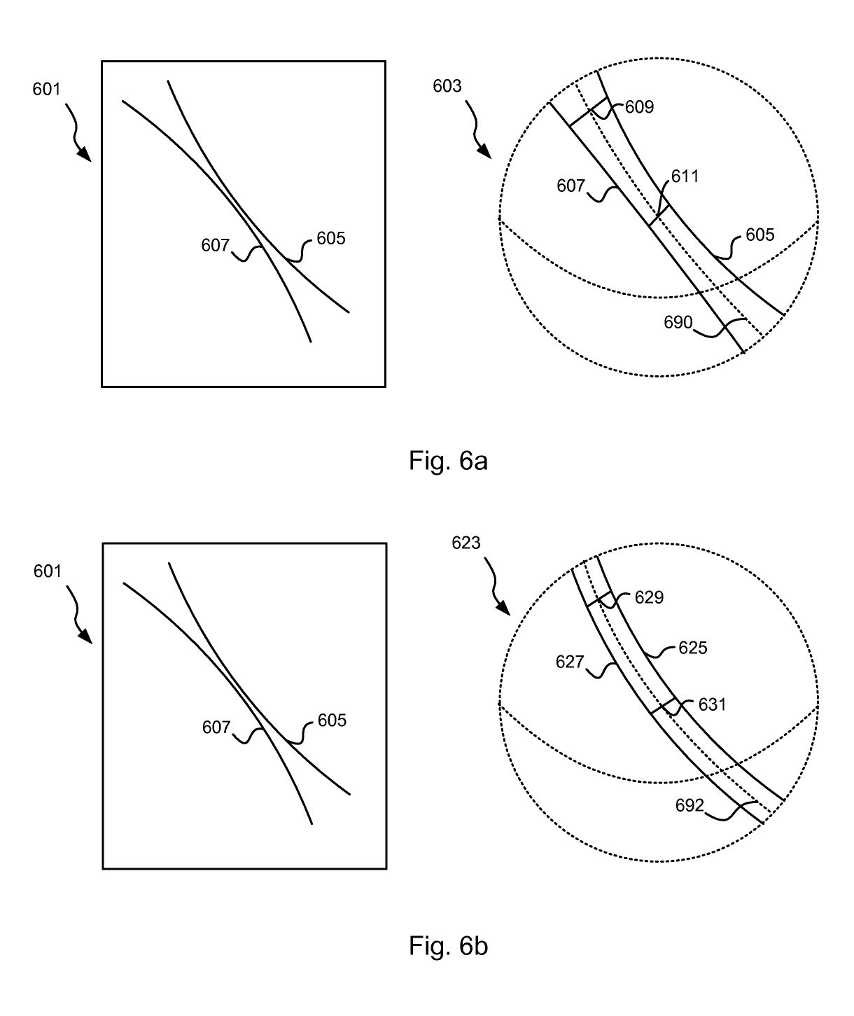

Turning to FIG. 5a, a flow diagram 500 depicts a method in accordance with some embodiments of the present invention for performing pattern center calibration. In the method, when the pattern center is correctly identified, it will result in parallel spherical bands. Where the pattern center is not correctly identified, the spherical bands will not be parallel. Said another way, the difference between outer edges off the band will be wider in some locations than others making them non-parallel. An example of a planar EBSD image 601 that is converted to a spherical representation 603 of the planar image is shown in FIG. 6a. As shown, because the pattern center has not been properly estimated, an outer edge 605 of a spherical band is farther from an outer edge 607 of the spherical band at a cross section location 609 than at a cross section location 611. As such, the parallel bands corresponding to planar EBSD pattern 601 are non-parallel. Of note, outer edge 605 and outer edge 607 follow a great circle 690 (i.e., a circular line of greatest length around the sphere) around the sphere. Thus, parallelism may also be determined in relation to how closely one or both of outer edge 605 and outer edge 607 follow great circle 690. For example, it could be determined whether outer edge 605 is substantially equidistant from great circle 690 at all points. In contrast, referring to FIG. 6b, using a different pattern center of planar EBSD image 601 yields a spherical representation 623. As shown, because the pattern center has been properly estimated, an outer edge 625 of a spherical band is approximately the same distance from an outer edge 627 of the spherical band at a cross section location 629 as at a cross section location 631. As such, the parallel bands corresponding to planar EBSD pattern 621 are parallel. Of note, outer edge 625 and outer edge 627 follow a great circle 692 (i.e., a circular line of greatest length around the sphere) around the sphere. Thus, parallelism may also be determined in relation to how closely one or both of outer edge 625 and outer edge 627 follow great circle 692. For example, it could be determined whether outer edge 627 is substantially equidistant from great circle 692 at all points. It should be noted that while FIGS. 6a-6b show a single spherical band with two outer edges, that more spherical bands may be included in the image and corresponding spherical conversion.

The process of flow diagram 500 operates to modify the pattern center until the spherical bands are approximately parallel. The process of flow diagram 500 may be used in place of the pattern center calibration (block 225) of FIG. 2. Following flow diagram 500, a pattern center is initially estimated (block 505). As used herein, the phrase “pattern center” refers to the coordinates of a point on the detector surface (e.g., a phosphor screen) relative to an origin on the detector surface (e.g., a corner of the detector surface), and a perpendicular distance from the point on the detector surface to the interaction point on the sample surface with the electron beam. This pattern center includes the point containing a line that passes through the material point of interaction between the electron beam and the sample. The EBSD image derived from the planar detector is mapped onto a sphere whose center is given by the assumed pattern center (block 510). Converting from the planar image to a spherical representation thereof may be done using coordinate transformation equations that are well known in the art.

A simulated spherical image is generated based upon Bragg's law that includes simulated spherical bands that correspond to the spherical bands from the image converted from the planar EBSD image (block 515). The simulated spherical image may be created using the same simulated image generation process discussed above in relation to block 250 of FIG. 2. Where the pattern center was correctly determined (block 505 or block 535), a band on the planar detector will map onto a parallel band centered on a great circle of the sphere (i.e., parallel spherical bands). Alternatively, where the pattern center was not correctly determined (block 505 or block 535), a band on the planar detector will not map onto a parallel band centered on a great circle of the sphere. A correlation difference between the spherical bands derived from the image gathered from the detector, and the simulated spherical bands is determined (block 520). The correlation difference may be calculated by comparing differences between the spherical EBSD image and the simulated spherical image. The comparison is done on a point by point basis, with the difference between the respective point comparisons being averaged together to yield a correlation difference. An exact correlation results in a correlation difference of zero, although an exact correlation is not necessarily found in all cases.

It is determined whether the correlation difference corresponds to a maximum correlation (block 525). In some cases, an iterative approach is used where the correlation difference for a number of estimated pattern centers are calculated, and the estimated pattern center yielding the smallest correlation difference (i.e., exhibiting the maximum correlation) is identified as the pattern center. Where the maximum correlation has not yet been identified (block 525), the estimated pattern center is adjusted to reduce the correlation difference (block 535), and the processes of blocks 510-525 are repeated for the newly estimated pattern center. Alternatively, where the maximum correlation is identified (block 525) the estimated pattern center corresponding to the maximum correlation is stored as the pattern center (block 530). This pattern center may then be used for the calculations discussed above in relation to FIG. 2.

Turning to FIG. 5b, a flow diagram 550 depicts a method in accordance with other embodiments of the present invention for performing pattern center calibration. As described above in relation to the method of FIG. 5a, when the pattern center is correctly identified, it will result in parallel spherical bands. Where the pattern center is not correctly identified, the spherical bands will not be parallel. Said another way, the difference between outer edges off the band will be wider in some locations than others making them non-parallel. The examples of FIGS. 6a-6b are applicable to this method as well. Again, it should be noted that while FIGS. 6a-6b show a single spherical band with two outer edges, that more spherical bands may be included in the image and corresponding spherical conversion.

Similar to the process described above in relation to FIG. 5a, the process of flow diagram 550 operates to modify the pattern center until the spherical bands are approximately parallel, and the process of flow diagram 500 may be used in place of the pattern center calibration (block 225) of FIG. 2. Following flow diagram 500, a pattern center is initially estimated (block 555). The EBSD image derived from the planar detector is mapped to a spherical EBSD image that includes spherical bands (block 560). Converting from the planar image to a spherical representation thereof may be done using coordinate transformation equations that are well known in the art.

The lengths of different cross sectional regions of the outer edges of the spherical bands are compared (block 565). This may include, but is not limited to, comparing the length of one cross sectional region with a number of cross sectional regions. Where the length of the different cross sectional regions are the same, the parallel bands are considered parallel. In contrast, the non-parallel nature of the bands increases as the difference between the lengths of cross sectional regions increases. It is determined whether the difference between cross sectional regions is less than a threshold value (block 570). Where the difference is not less than the defined threshold (block 570), the spherical bands derived from the image gathered from the detector are not considered sufficiently parallel. In this case, the estimated pattern center is adjusted to reduce the difference and thus increase the degree of parallelism (bock 575), and the processes of blocks 560-570 are repeated for the newly estimated pattern center. Alternatively, where the difference is less than the defined threshold (block 570), the spherical bands derived from the image gathered from the detector are considered sufficiently parallel. In such a case, the estimated pattern center is stored as the pattern center (block 580). This pattern center may then be used for the calculations discussed above in relation to FIG. 2. It should be noted that parallelism may also be determined by determining how closely one or both of the outer edges of the spherical bands deviates from a great circuit passing between the outer edges.

The aforementioned approaches and/or portions thereof may be used in a variety of novel applications. For example, in some cases, the technology may be applied to determining mis-orientation between two points in a sample, or for determining a crystal structure of a sample. Determining the mis-orientation between two points may include: receiving a first measured image of the sample; calculating a first lattice orientation of the sample based at least in part on the measured image for a first point of the sample; generating a first simulated image corresponding to an expected crystal structure of the sample and the calculated first lattice orientation; correlating the generated first simulated image with the first measured image to determine a first displacement gradient tensor; based at least in part on the first displacement gradient tensor, modifying the first lattice orientation to yield a first modified lattice orientation; receiving a first measured image of the sample; calculating a second lattice orientation of the sample based at least in part on the measured image for a second point of the sample; generating a second simulated image corresponding to the expected crystal structure of the sample and the calculated second lattice orientation; correlating the generated second simulated image with the second measured image to determine a second displacement gradient tensor; based at least in part on the second displacement gradient tensor, modifying the second lattice orientation to yield a second modified lattice orientation; and calculating a mis-orientation between the first modified lattice orientation and the second modified lattice orientation to yield an mis-orientation output. Determining a crystal structure of a sample may include: (a) receiving a measured image of the sample; (b) calculating a lattice orientation of the sample based at least in part on the measured image; (c) generating a first simulated image corresponding to a first comparative crystal structure of the sample and the calculated lattice orientation; (d) correlating the generated first simulated image with the measured image to determine a first displacement gradient tensor; (e) based at least in part on the first displacement gradient tensor, updating the calculated lattice orientation; (f) repeating elements (c) through (f) at least once to yield a first final displacement gradient tensor; (g) generating a second simulated image corresponding to a second comparative crystal structure of the sample and the calculated lattice orientation; (h) correlating the generated second simulated image with the measured image to determine a second displacement gradient tensor; (i) based at least in part on the second displacement gradient tensor, updating the calculated lattice orientation; (j) repeating elements (g) through (i) at least once to yield a second final displacement gradient tensor; and comparing the first final displacement gradient tensor with the second final displacement gradient tensor to identify the crystal structure as one of first comparative crystal structure or the second comparative crystal structure. Based upon the disclosure provided herein, one of ordinary skill in the art will recognize other applications.

In conclusion, the invention provides novel systems, devices, methods and arrangements for determining elastic strain in a material. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A method for determining crystallographic characteristics of a sample, the method comprising:
(a) receiving a measured image of the sample;
(b) calculating a lattice orientation of the sample based at least in part on the measured image;
(c) generating a simulated image corresponding to an expected crystal structure of the sample and the calculated lattice orientation;
(d) calculating a difference between the measured image and the simulated image; and
(e) calculating a displacement gradient tensor based at least in part on the difference.

2. The method of claim 1, wherein the measured image is an EBSD pattern.

3. The method of claim 2, wherein the method further comprises:
providing an electron microscope, wherein the electron microscope directs a band of electrons toward the sample; and
providing a detector, wherein the detector creates a preliminary image based upon a number of electrons emitted from the sample due to the band of electrons that interact with the detector, and wherein the measured image is a derivative of the preliminary image.

4. The method of claim 2, wherein the method further comprises:
processing the measured image to improve the quality of the EBSD pattern.

5. The method of claim 1, wherein calculating the difference includes cross correlating the measured image with the simulated image.

6. The method of claim 5, wherein the cross correlating is performed using fast Fourier transforms.

7. The method of claim 1, wherein calculating the lattice orientation of the sample based at least in part on the measured image includes:
detecting bands in the measured image using a method selected from a group consisting of: a Hough transform method, a Radon transform method, and the Burns method.

8. The method of claim 1, wherein generating the simulated image includes:
using a model selected from a group consisting of: a kinematical based model of electron diffraction, and a dynamical based model of electron diffraction.

9. The method of claim 1, wherein the method further comprises:
segregating the measured image into a plurality of sub-regions;
segregating the simulated image into the plurality of sub-regions; and
wherein calculating a difference between the measured image and the simulated image is done on a sub-region by sub-region basis.

10. The method of claim 9, wherein the method further comprises:
(f) re-calculating the lattice orientation of the sample based at least in part on the displacement gradient tensor;
iteratively performing the elements (c), (d) and (e) until the displacement gradient tensor exhibits a predefined condition; and
wherein determining whether the displacement gradient tensor exhibits the predefined condition includes a process selected from a group consisting of:
summing the magnitudes of calculated differences from the plurality of sub-regions to yield a difference value, and determining whether the difference value is below a predefined threshold; and
calculating a factor based on the magnitudes of the components of the displacement gradient tensor, and determining whether the factor is below a predefined threshold.

11. The method of claim 1, wherein the method further comprises:
(f) calculating an elastic strain tensor for the sample based at least in part on the displacement gradient tensor, wherein the simulated image corresponds to a material assumed to be free of elastic strain.

12. The method of claim 11, wherein the method further comprises:
performing the processes of (c), (d), (e) and (f) for a plurality of points on the sample.

13. The method of claim 1, wherein the method further comprises:
performing a pattern center calibration, wherein the pattern center calibration approximates the pattern center of the measured image.

14. The method of claim 13, wherein the measured image is represented in spherical coordinates and includes at least one spherical band including a first outer edge and a second outer edge, and wherein the pattern center calibration includes:
(f) estimating a pattern center; and
(g) determining whether the estimated pattern center yields the at least one spherical band with the first outer edge substantially parallel to the second outer edge.

15. The method of claim 14, wherein the method further comprises:
iteratively performing the processes of elements (f) and (g) until a degree of parallelism of the first outer edge relative to the second outer edge is within a pre-defined convergence criterion.

16. The method of claim 13, wherein the measured image is represented in spherical coordinates, and wherein the pattern center calibration includes:
(f) estimating a pattern center; and
(g) determining whether the estimated pattern center yields a series of bands corresponding to the image represented in spherical coordinates centered on great spheres with parallel edges.

17. A system for determining crystallographic characteristics of a sample, the system comprising:
a data processing circuit, wherein the data processing circuit is operable to:
(a) receive a measured image of the sample;
(b) receive a simulated image corresponding to the sample, wherein the simulated image is substantially free of elastic strain;
(c) compare the measured image with the simulated image to yield a difference, wherein at least a portion of the difference corresponds to an elastic strain of the sample; and
(d) calculate the elastic strain of the sample using the difference.

18. The system of claim 17, wherein the system further comprises:
an electron microscope, wherein the electron microscope directs a band of electrons toward the sample; and
a detector, wherein the detector creates a preliminary image based upon a number of electrons emitted from the sample due to the band of electrons that interact with the detector, and wherein the measured image is a derivative of the preliminary image.

19. The system of claim 17, wherein the data processing circuit is further operable to:
(e) calculate the lattice orientation of the sample based at least in part on the difference, wherein the simulated image corresponds to the sample at the calculated lattice orientation;
iteratively perform the elements (b), (c) and (e) until the difference is less than a predefined threshold; and
wherein the elastic strain of the sample is calculated using the difference remaining after iteratively performing the elements (b), (c) and (e).

20. The system of claim 17, wherein the system further comprises:
a pattern center estimation circuit, wherein the pattern center estimation circuit is operable to perform a pattern center calibration, wherein the pattern center calibration approximates the pattern center of the measured image.

21. A method for determining crystallographic characteristics of a sample, the method comprising:
receiving a measured image of the sample;
receiving a simulated image corresponding to the sample, wherein the simulated image is substantially free of elastic strain;
comparing the measured image with the simulated image, wherein at least a portion of a difference between the measured image and the simulated image corresponds to an elastic strain of the sample; and
using the difference to calculate the elastic strain of the sample.

22. A method for determining the mis-orientation between two points in a sample, the method comprising:
(a) receiving a first measured image of the sample;
(b) calculating a first lattice orientation of the sample based at least in part on the measured image for a first point of the sample;
(c) generating a first simulated image corresponding to an expected crystal structure of the sample and the calculated first lattice orientation;
(d) correlating the generated first simulated image with the first measured image to determine a first displacement gradient tensor;
(e) based at least in part on the first displacement gradient tensor, modifying the first lattice orientation to yield a first modified lattice orientation;
(f) receiving a first measured image of the sample;
(g) calculating a second lattice orientation of the sample based at least in part on the measured image for a second point of the sample;
(h) generating a second simulated image corresponding to the expected crystal structure of the sample and the calculated second lattice orientation;
(i) correlating the generated second simulated image with the second measured image to determine a second displacement gradient tensor;
(j) based at least in part on the second displacement gradient tensor, modifying the second lattice orientation to yield a second modified lattice orientation;
(k) calculating a mis-orientation between the first modified lattice orientation and the second modified lattice orientation to yield an mis-orientation output.

23. A method for determining a crystal structure of a sample, the method comprising:
(a) receiving a measured image of the sample;
(b) calculating a lattice orientation of the sample based at least in part on the measured image;
(c) generating a first simulated image corresponding to a first comparative crystal structure of the sample and the calculated lattice orientation;
(d) correlating the generated first simulated image with the measured image to determine a first displacement gradient tensor;
(e) based at least in part on the first displacement gradient tensor, updating the calculated lattice orientation;
(f) repeating elements (c) through (f) at least once to yield a first final displacement gradient tensor;
(g) generating a second simulated image corresponding to a second comparative crystal structure of the sample and the calculated lattice orientation;
(h) correlating the generated second simulated image with the measured image to determine a second displacement gradient tensor;
(i) based at least in part on the second displacement gradient tensor, updating the calculated lattice orientation;
(j) repeating elements (g) through (i) at least once to yield a second final displacement gradient tensor;
comparing the first final displacement gradient tensor with the second final displacement gradient tensor to identify the crystal structure as one of first comparative crystal structure or the second comparative crystal structure.
